(19) United States
(12) Patent Application Publication
(10) Pub. No.: US 2023/0140552 A1
(43) Pub. Date: May 4, 2023

(54) DEVELOPMENT ENVIRONMENT SETUP FOR COMMONLY USED COMPONENTS ACROSS TEAMS

(71) Applicant: Capital One Services, LLC, McLean, VA (US)

(72) Inventors: Levent TURGUT, Frisco, TX (US); Shiv SOMASHEKHAR, Plano, TX (US); Harish KATHPALIA, Plano, TX (US)

(73) Assignee: Capital One Services, LLC, McLean, VA (US)

(21) Appl. No.: 17/512,789

(22) Filed: Oct. 28, 2021

(51) Int. Cl. G06F 11/36; G06Q 10/10

(52) U.S. Cl. CPC G06F 11/3664; G06F 11/3688; G06Q 10/101

(57) ABSTRACT

Disclosed herein are system, method, and computer program product embodiments for utilizing non-RAM memory to implement a code product development environment, including at least a first development sandbox and the second development sandbox. The sandboxes are configured to include a sandbox copy of a subset of coding components and common test data. Based on testing with the common test data, a first product component is promoted from the first development sandbox and a second product component from the second development sandbox to a product component integration environment to generate an integrated product. Based on testing using the common test data, the integrated product is promoted to a staging environment to generate a staged product. Based on performance testing, the staged product is promoted to a production environment.

### BACKGROUND

In large software engineering groups, when a large number of teams work on the same product line, the commonly used/modified components become a bottleneck in the continuous integration and continuous delivery process. Because of this, as teams deploy their code changes, they run into code conflicts, and testing and deployment coordination issues at the higher environments (integration, staging, performance). These conflicts cause issues to be found at later stages of development and deployment and may result in production delays and rework.

### BRIEF DESCRIPTION OF THE DRAWINGS

The accompanying drawings are incorporated herein and form a part of the specification.

FIG. 1 is a block diagram of a code development system that includes a dedicated sandbox environment, according to some embodiments.

FIG. 2 is a flowchart illustrating a process for code development that includes a dedicated sandbox environment, according to some embodiments.

FIG. 3A is a flowchart illustrating an example process for code development that includes a dedicated sandbox environment, according to some embodiments.

FIG. 3B is a flowchart illustrating an example process for code development that includes a dedicated sandbox environment, according to some embodiments.

FIG. 3C is a flowchart illustrating an example process for code development that includes a dedicated sandbox environment, according to some embodiments.

FIG. 4 is a flowchart illustrating a process for code development that includes a dedicated sandbox environment, according to some embodiments.

FIG. 5 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a secure environment for each individual code portion development team within a larger product development team. In some embodiments, the technology described herein is configured to generate a code development environment for continuous code development, integration, testing and delivery.

In some embodiments, the technology described herein is configured as a hierarchical code production structure (bottom-to-top) of code development of teams, integration, staging/performance and production. The code development teams may be configured as dedicated sandbox environments for each team participating in a product's code development. Sandboxing protects “live” servers and their data, vetted source code distributions, and other collections of code, data and/or content, proprietary or public, from changes that could be damaging to a mission-critical system or which could simply be difficult to revert, regardless of the intent of the author of those changes. Sandboxes replicate at least the minimal functionality needed to accurately test the programs or other code under development (e.g. usage of the same environment variables as, or access to an identical database to that used by, the stable prior implementation intended to be modified.

In some embodiments, common coding components needed for coding are retained within each team sandbox. Common coding components ensure that conflicts for code development teams needing these components will be reduced or eliminated. In one non-limiting example, a common component may include an API component that serves/provides functionality for multiple front-end libraries or components. Common components, in some embodiments, are used to share the same functionality across teams without duplicating the code/functionality multiple times. These components reduce and eliminate code duplication or creating separate components for each team. In addition, common components may cover the same/similar related functionalities and reduce the development time.

In some embodiments, each level of the production infrastructure is connected to the same test data instead of allowing each coding team to have their own unique test data. For example, a code development hierarchical structure of teams, integration, staging, performance, and production may point to a same underlying testing database (DB) and associated downstream systems. Downstream systems may include outside components, generic API components, other databases that system components may depend on (e.g., consumed by the system components.) By testing each completed code portion against a common set of test data, code production environment continuity may be ensured.

In some embodiments, a code repository or branch (i.e., controlled path) is assigned to each team developing a portion of code for a product. A repository or a branch retains a copy of a component code in a version control system that is created for a specific code change or functionality implementation. These code copies may, in some embodiments, be stored separately in a version control system, such as GitHub, to be used by teams/users to implement a separate instance to prepare the code for merger with the original code stream after the implementation is complete. As portions of code are developed, a governance process is implemented to review and promote code changes within environmental levels of the hierarchical structure. The team assigned branches provide a mechanism for automatic upward mobility of completed and tested code portions as well as a mechanism for synchronizing/fixing completed code portions at each level. For example, when a code development team completes and successfully tests a portion of code for a product, the portion may be promoted to a next level in the hierarchical code production structure using a branch assigned to that team. In another non-limiting example, modifications to a code portion made at a staging level may be passed back to the team through the assigned branch so that the corresponding team sandbox has the most recent version. In another non-limiting example, if an error in that portion of code is discovered at a higher level in the hierarchical code production structure, a copy of the portion may be passed back to the associated team sandbox to be repaired (fixed) through their assigned branch.

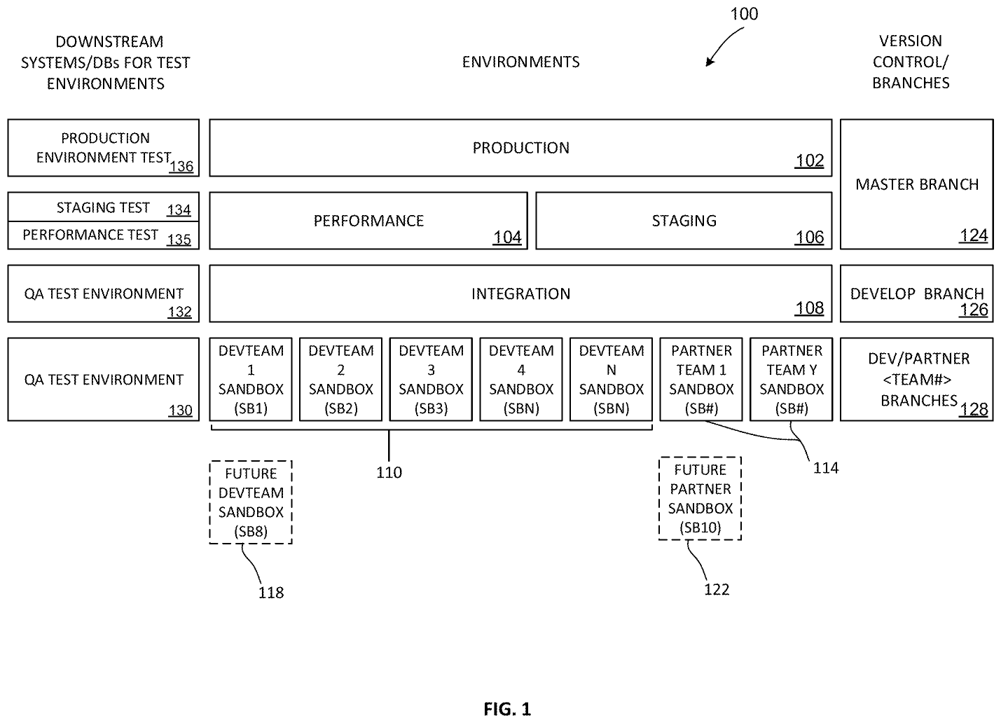

The technology described herein solves one or more technical problems that exist in the realm of computer systems (e.g., computer code generation). Problems such as code conflicts and testing and deployment coordination issues may be a direct result of various parts of a computer code generation process being simultaneously performed by multiple participants using common code components. Therefore, one or more solutions described herein are necessarily rooted in computer technology in order to overcome the problem specifically arising in the realm of computer networks. The technology described herein reduces or eliminates this problem with a sandbox environment and a continuous integration and delivery infrastructure as will be described in the various embodiments of FIGS. 1-5.

In a non-limiting example, the technology described herein is configured to allow a large number of coding teams to work on common coding components in their isolated environment without conflicting with other teams. In another non-limiting example, the technology described herein is configured to allow coding teams to promote their code to a higher environment by continuously integrating another team's code into the environment. In another non-limiting example, the technology described herein is configured to prevent coding teams from blocking higher environments due to testing and issue identification in a later stage of code development. In another non-limiting example, the technology described herein is configured to prevent coding teams from incurring production deployment delays.

FIG. 1 is a block diagram of a code development system that includes a dedicated sandbox environment, according to some embodiments. System 100 may be performed by processing logic that can comprise hardware (e.g., circuitry, dedicated logic, programmable logic, microcode, etc.), software (e.g., instructions executing on a processing device), or a combination thereof. It is to be appreciated that not all elements may be needed to perform the disclosure provided herein. Further, some of the processes described may be performed simultaneously, or in a different order than shown in FIG. 1, as will be understood by a person of ordinary skill in the art.

It is common for large software engineering groups to share commonly used or modified code development components. In a non-limiting example, commonly used or modified code development components may include a BFF (backend for front end) component used by more than one front end libraries or components or an API component providing specific functionality for multiple other components. When a large number of teams work on the same product line, the commonly used/modified components may become a bottleneck in the continuous integration and continuous delivery process. As shown in FIG. 1, the technology described herein is configured as a hierarchical code development environment for continuous code development, integration, testing and delivery.

System 100 may be configured with a plurality of environments to include, but not limited to, a team level for code/product development (110 and 114), an integration environment 108 for integrating various completed code passed (promoted) from individual teams at the team level to the integration level. Integrated code is automatically passed to a staging environment 106 where the various integrated code sections are staged. The staging environment may be configured as a nearly exact replica of a production environment for software testing. Staging environments are made to test codes, builds, and updates to ensure quality under a production-like environment before application deployment. Upon successful QA staging testing 134, staged code is automatically passed to a performance environment 104 for QA performance testing 135, such as, stress testing, load testing, and speed testing. Upon passing performance testing, the performance-tested code is automatically passed into a production environment 102 for subsequent production environment testing 136 and deployment. Alternatively, or in addition, additional environments or sub-environments may be added to the system without departing from the scope of the technology described herein.

At the coding team level, a plurality of sandboxes may be created for each development team 110 (DEVTEAM N, SANDBOX N) or partner team 114 (PARTNERTEAM Y, SANDBOX #). These sandboxes may be arranged in any order and numbered as they are created without departing from the scope of the technology described herein. In addition, future team sandboxes may be created in advance or ad hoc for the development team(s) 118 and the partner team(s) 122. Sandboxes are isolated testing environments that allow coders to run programs or execute files without affecting the application, system or platform on which they run. Therefore software developers may use the sandboxes 110 to test new programming code. For example, Cybersecurity professionals may, in some embodiments, use the team sandboxes 110 to test potentially malicious software. Third party or teams outside the primary development teams may have partner sandboxes 114 configured to run programs or execute files without affecting the applications within the primary development team environment.

Each sandbox created may retain a copy of common coding components, point to a common test environment 130 (e.g., the same test data), and include an integration of team code. Each team sandbox may be connected to other levels through various code repositories or branches (124, 126 and 128). Dev/Partner team branch 124 may include code repositories (private copies) created for each development team. The team branches include the copy of the code for a component or functionality and may be used for the teams to update/modify these private copies and deliver the functionalities into their specific sandbox environments. The system may also test the functionality privately in these sandboxes before they move the code changes to the higher environment (Integration and staging). Develop branch 126 may include a single copy of the integrated code for functionality or a component. Develop branch 126 is used to push the code changes performed in each team branch to the integration environment. The code built in the develop branch may be deployed to the integration environment and the functionality tested for integrated content.

Master Branch 124 may contain the main code copy that is ready to be tested and pushed to production. For example, the master branch 124 may include a production ready version of the code. The code for specific functionality is promoted to the master branch after the integration tests are completed and verified in the integration environment. When the code is moved to the master branch, it is built and deployed to the staging 106 and performance 104 environments. Subsequently, functional and performance tests are executed in the corresponding environments and the code readiness for production 102 is verified.

The integration environment 108 receives QA tested code from the various team sandboxes 110 and 114 as code testing is completed by each team. The integration environment is configured for continuous integration (merging) where team-working copies of code are shared continuously as they are produced or at some set schedule (e.g., each hour or several times a day). At the integration environment level, the development branch 126 may transmit a pull request to a team level sandbox to pull code up a level and merge it with other code present in the integration level. QA test environment 132 points to the same test data environment as QA test environment 130. The integration environment 108 may perform testing of the integrated code to include, but not limited to, full regression testing. Regression testing may include re-running functional and non-functional tests to ensure that previously developed and tested software still performs after a change (e.g., integration). Changes that may require regression testing include, but are not limited to, bug fixes, software enhancements or configuration changes. When the code is deployed to the integration environment, the regression tests are triggered. In one non-limiting example, when regression testing is complete, the test results are sent to the development teams as an attachment to an email. The attachment includes the test results and pass/fail ratio. If there are failures in the tests, the development team included in the failed code analyzes the issues and fixes (repairs) it to advance it upward in the structure 100 or rolls back the code and fixes the issue in their team development environment and subsequently promotes the code again back to the integration environment at a later time.

At the staging environment level 106, code that has been integrated and tested is staged. As previously described, staging environments test codes, builds, and updates to ensure quality under a production-like environment before application deployment. The QA staging test environment 134 can connect to either the existing QA test environment 132 or may include a specific QA staging test environment. While illustrated as separate QA test environments, 130, 132 and 134, in some embodiments, may be the same testing environment. Successfully tested code is automatically deployed to the performance environment 104.

Performance testing 135 may include testing for activity that determines a robustness of the staged code by testing beyond the limits of normal operation (e.g., stress testing, load testing and speed testing, etc.). Stress testing is particularly important for “mission critical” software, but may be implemented for all types of software. Stress tests commonly put a greater emphasis on robustness, availability, and error handling under a heavy load, than on what would be considered correct behavior under normal circumstances. Load testing generally refers to the practice of modeling the expected usage of code (program) by simulating multiple users accessing the code (program) concurrently. Speed testing may include testing against known speed benchmarks for various configurations or uses.

Upon successful performance testing, the tested code is automatically passed to the production layer. The production environment is also known as live, particularly for servers, as it is the environment that users directly interact with. Deploying to production may be implemented by deploying new code directly (overwriting old code, so only one copy is present at a time), or by deploying a configuration change. This can take various forms: deploying a parallel installation of a new version of code, and switching between them with a configuration change; deploying a new version of code with the old behavior and a feature flag, and switching to the new behavior with a configuration change that performs a flag flip; or by deploying separate servers (one running the old code, one the new) and redirecting traffic from old to new with a configuration change at the traffic routing level. These in turn may be performed all at once or gradually, in phases.

The staging, performance and production layers are controlled by master branch 124. Master branch 124 may control movement of the code through the staging, performance and production layers, version control and subsequent testing phases. In addition, master branch 124 may revert unsuccessfully tested code (e.g., bugs, incomplete threads, etc.) to any lower environment level for correction, refreshing (e.g., synchronization with other code) and subsequent deployment up through the various environment levels.

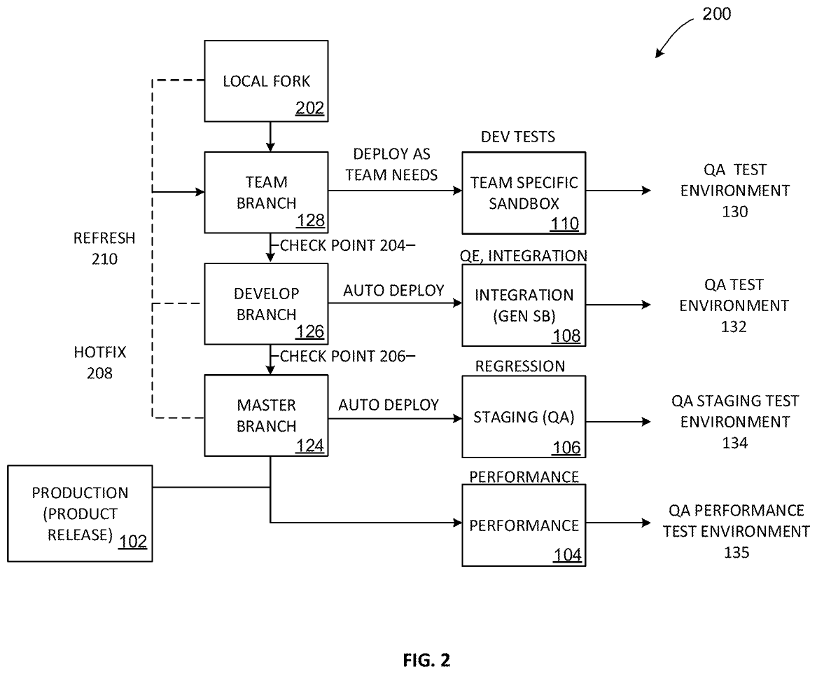

FIG. 2 is a flowchart illustrating a process for code development that includes a dedicated sandbox environment, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art.

In some embodiments, method 200 may illustrate various branching strategies. However, one skilled in the art will appreciate that other approaches and branching strategies may be contemplated within the scope of the technology described herein.

Local fork 202 may retain a copy of a repository of code information. Most commonly, forks are used to propose changes to another coding project or to use another coding project as a starting point for a new idea. In a non-limiting embodiment, a local fork may be a copy of a functionality code in a developer's local laptop or personal computer (PC). This may be the first copy that a developer uses to change the code to implement a functionality. A developer may also use their local fork to test their code changes locally before pushing the code to their team development branch. Therefore, forking a repository allows the developers to freely experiment with changes without affecting the original project. For example, the developers can fork a repository to create a copy of the repository and make changes without affecting the upstream repository. For example, the fork may be configured to propose changes related to fixing a bug.

Code information (e.g., coding for a product) stored in local fork 202 may be distributed (deployed) to applicable team sandboxes 110/114 as needed by each individual team. For example, a team working on developing a user interface (UI) may receive UI related code and configurations. For example, team branch 128 deploys the corresponding code (e.g., coding for a portion of the product) as needed by a team to a team sandbox 110. As code is completed (by each team), the code is tested for quality by QA testing 130.

Checkpoint 204 is included in-between team branch 128 and development branch 126. This checkpoint allows for a high-level of review of the code. The review may be performed manually, for example, by master engineers, may be performed semi-automatically (e.g., using pull request (PR) templates) or may be performed automatically using known code review systems and processes. In some embodiments, only production ready code is accepted for advancement to the integration level 108. Develop branch 126 automatically deploys code received for integration (merging) with other advanced code sets. Integrated code is sent to QA test environment 132 for regression testing as previously described. As with checkpoint 204, second checkpoint 206 may also review the code one more time before it is merged to the master branch. While these code reviews are performed at these checkpoints, if there are any code changes applied or if there are any hotfixes 208 needed for the existing product code, the changes may also be applied to the lower branches such as the develop branch 126. In order to keep the develop branch 126 and the team branches 128 in sync, a refreshing (rebasing) strategy is configured to synchronize the code base. Refreshing may be performed in real-time or at discrete time points (e.g., hourly, daily, weekly, etc.). In addition, refreshing will generate an automatic pull request (PR) in case of any coding conflicts. Resolving conflicts and merging PRs may be implemented at the team level. Refreshing results will be shared for the various team sandboxes to act on. For example, refreshing or rebasing processes automatically update/merge the code from the higher branches to the lower branches. However, in some scenarios there might be code conflicts that cannot be resolved automatically. In one non-limiting example, a pull request may be raised and the system expects a developer to check the code from the higher environment or from the lower environment to decide which one should be pulled without breaking functionality of the code.

Master branch 124 passes completed code to the staging environment 106 and performance environment 104 as previously discussed for testing 134/135 and subsequent deployment through production environment 102.

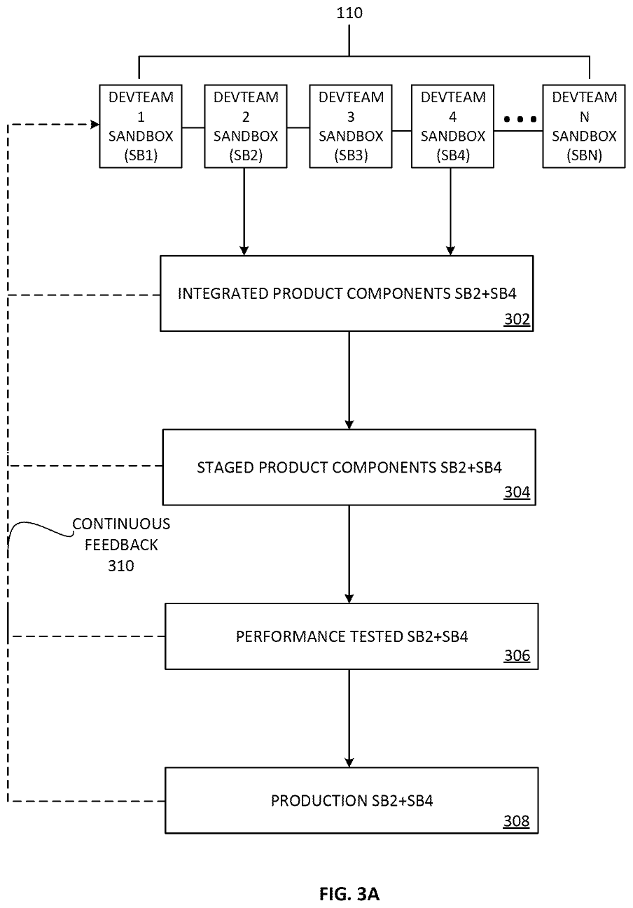

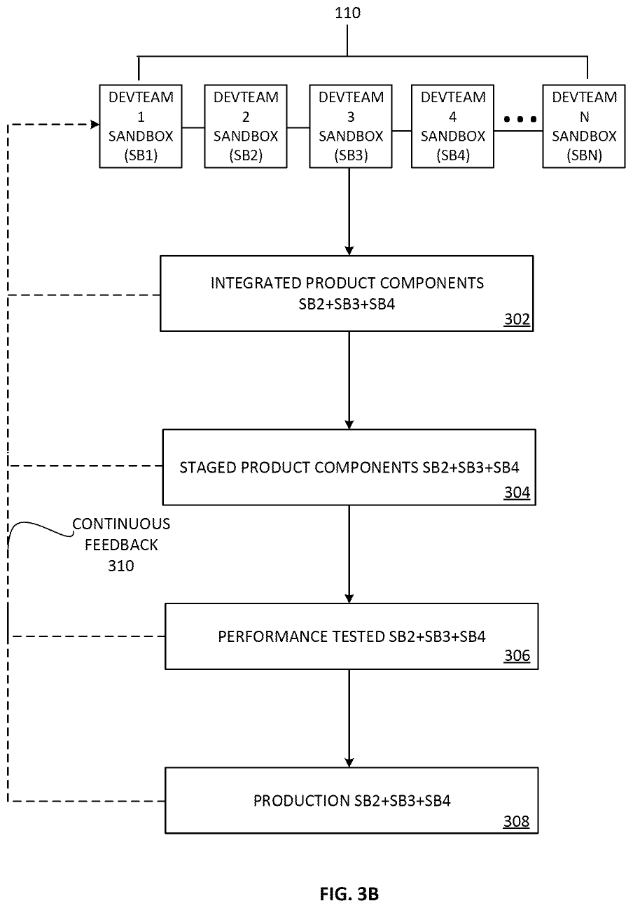

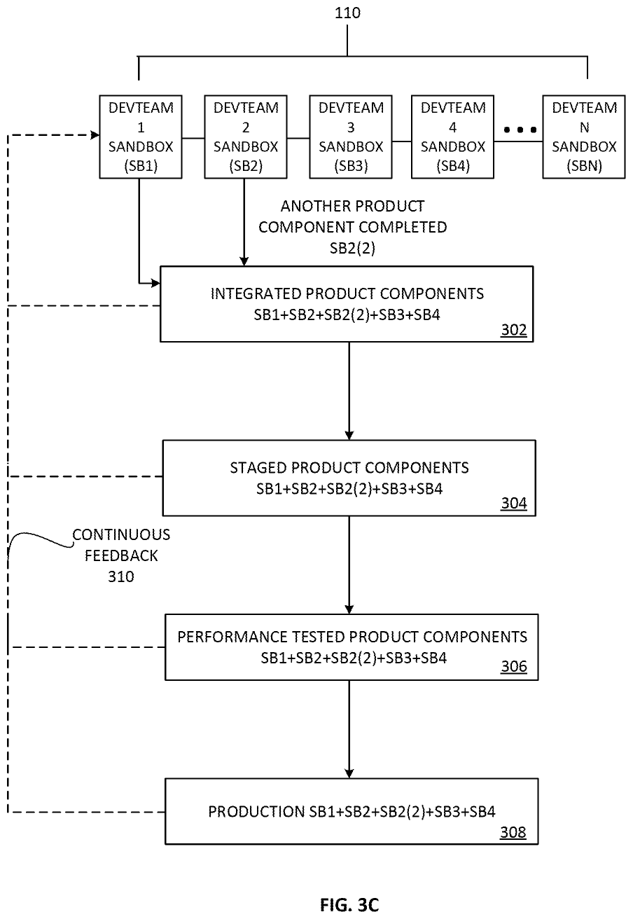

FIGS. 3A-3C illustrate an example code production flow. FIG. 3A is a flowchart illustrating an example process for code development that includes a dedicated sandbox environment, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3A, as will be understood by a person of ordinary skill in the art.

As shown, development teams 2 and 4 (110—DEVTEAM 2, SANDBOX 2 and DEVTEAM 4, SANDBOX 4) both complete a portion of code (components) for a product. These completed components (SB2 and SB4) are pulled to the integration environment level 302, merged together, tested and, as no other code components have been completed, advanced through the staging, performance and production levels. In some embodiments, where the code represents a fix for existing code, the code may be deployed as an update. Changes made at the various levels (302-308) are synchronized at the lower levels using continuous feedback 310, such as, by refreshing as previously described.

FIG. 3B is a flowchart illustrating an example process for code development that includes a dedicated sandbox environment, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3B, as will be understood by a person of ordinary skill in the art.

As shown, development team 3 (110—DEVTEAM 3, SANDBOX 3) completes another portion of code (components) for a product. This completed component (SB3) is pulled to the integration environment level 302, merged together with SB2 and SB4, tested and, as no other code components have been completed, advanced through the staging, performance and production levels. In some embodiments, where the code represents a fix for existing code, the code may be deployed as an update. Changes made at the various levels (302-308) are synchronized at the lower levels using continuous feedback 310, such as, by refreshing as previously described.

FIG. 3C is a flowchart illustrating an example process for code development that includes a dedicated sandbox environment, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3C, as will be understood by a person of ordinary skill in the art.

As shown, development team 1 (110—DEVTEAM 1, SANDBOX 1) completes a portion of code and development team 2 (110—DEVTEAM 3, SANDBOX 3) completes a second portion of code (components) for a product. These completed components (SB1 and SB2(2)) are pulled to the integration environment level 302, merged together as SB1, SB2, SB2(2), SB3 and SB4, tested and, as no other code components have been completed advanced through the staging, performance and production levels (where they are held until the product is completed). In some embodiments, where the code represents a fix for existing code, the code may be deployed as an update. Changes made at the various levels (302-308) are synchronized at the lower levels using continuous feedback 310, such as, by refreshing as previously described.

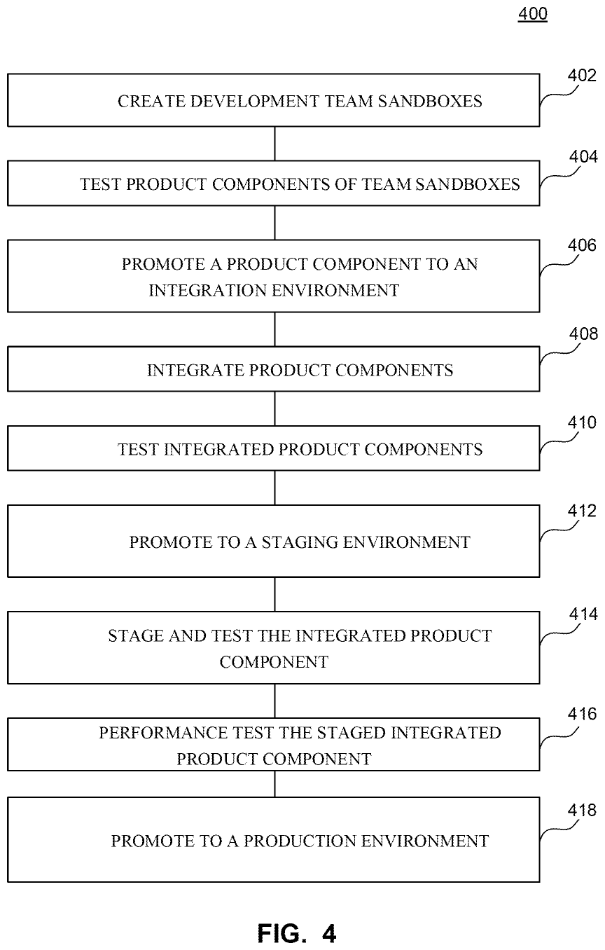

FIG. 4 is a flowchart illustrating a process for code development that includes a dedicated sandbox environment, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

In 402, the code development system creates a plurality of sandboxes for each development team or partner team. These sandboxes may be arranged in any order and numbered as they are created without departing from the scope of the technology described herein. In addition, future team sandboxes may be created in advance or ad hoc for the development team(s) and the partner team(s).

Each sandbox created may retain a copy of common coding components, point to a common test environment (e.g., same test data), and include an integration of team code. Each team sandbox may be connected to other levels through various branches. A team branch may be instantiated for each team sandbox to connect the team sandboxes to the integration environment through the development branch.

In 404, the code development system tests completed code portions from each of the sandboxes as the code portions are completed. Upon successful completion of testing, the code portion(s) are, in 406, promoted to an integration environment 108.

In 408, the integration environment 108 receives the tested code portions from the various team sandboxes as code portions are completed by the team. The integration environment is configured for continuous integration (merging) where team-working copies of code are shared continuously as they are produced or at some set schedule (e.g., each hour or several times a day). At the integration environment level, the development branch may transmit a pull request to a team level sandbox to pull code up a level and merge it with other code present in the integration level.

In 410, the code integration system tests the integrated code portions. The integration environment may perform testing of the integrated code to include, but not limited to, full regression testing or functional tests. Functional tests may be created based on users actions/clicks to run a functionality and verify that the screens are rendered properly or that a user achieves expected results or a response back from that functionality.

As testing is completed, the integration level provides feedback to the team sandbox level through the development branch to the team sandboxes through the instantiated team branches. In some embodiments, the testing feedback is provided to every team sandbox so that all teams have the most current code information.

The tested integrated code portions are, in 412, passed (promoted) by the code integration system to the staging environment level. In 414, the code integration system is staged and tested for quality assurance. As previously described, staging environments are made to test codes, builds, and updates to ensure quality under a production-like environment before application deployment. In this step, the functional tests will be executed and verified that the functionality is running as expected and as designed. Successfully tested code is automatically deployed to the performance testing environment.

In 416, the code integration system performance tests the staged code portions for activity that determines a robustness of the staged code by testing beyond the limits of normal operation (e.g., stress testing, load testing and speed testing, etc.). In one non-limiting example, performance tests will check and validate the functionality performance, such as a web page rendering time or time spent to receive data from the downstream components or click responses time for each user clicks during the functionality execution. Upon successful performance testing, the tested code, in 418, is automatically promoted to a production environment. Deploying (promoting) to production may be implemented by deploying new code directly (overwriting old code, so only one copy is present at a time), or by deploying a configuration change. This can take various forms: deploying a parallel installation of a new version of code, and switching between them with a configuration change; deploying a new version of code with the old behavior and a feature flag, and switching to the new behavior with a configuration change that performs a flag flip; or by deploying separate servers (one running the old code, one the new) and redirecting traffic from old to new with a configuration change at the traffic routing level. These in turn may be done all at once or gradually, in phases.

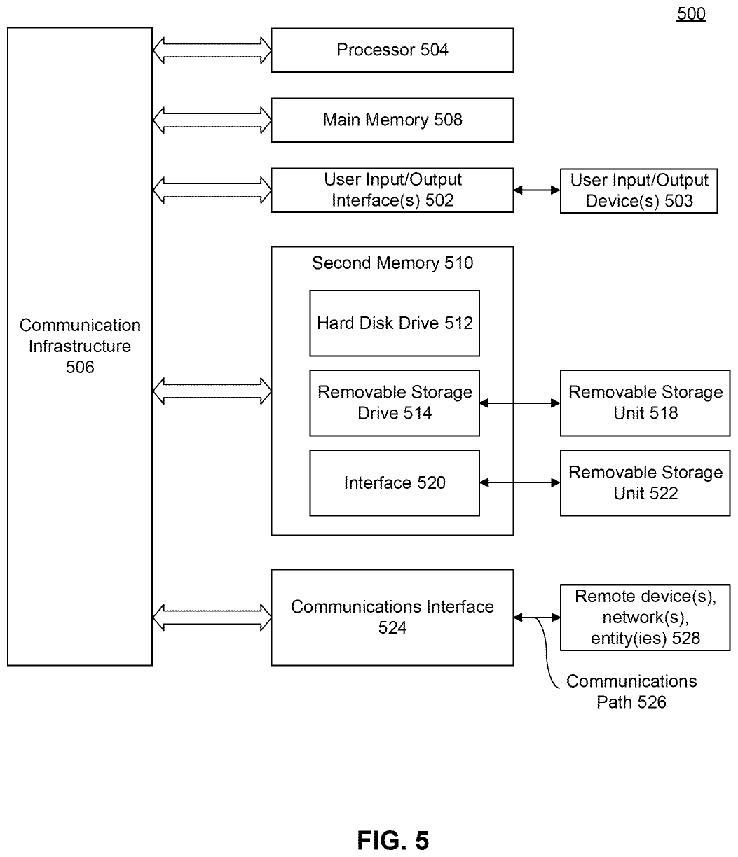

Various embodiments can be implemented, for example, using one or more computer systems, such as computer system 500 shown in FIG. 5. Computer system 500 can be used, for example, to implement method 400 of FIG. 4. Computer system 500 can be any computer capable of performing the functions described herein.

Computer system 500 can be any well-known computer capable of performing the functions described herein.

Computer system 500 includes one or more processors (also called central processing units, or CPUs), such as a processor 504. Processor 504 is connected to a communication infrastructure or bus 506.

One or more processors 504 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 also includes user input/output device(s) 503, such as monitors, keyboards, pointing devices, etc., that communicate with communication infrastructure 505 through user input/output interface(s) 502.

Computer system 500 also includes a main or primary memory 508, such as random access memory (RAM). Main memory 508 may include one or more levels of cache. Main memory 508 has stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to an exemplary embodiment, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method for a product development environment, comprising:
creating a first development sandbox and a second development sandbox in a product development environment, wherein the first development sandbox and the second development sandbox are configured to include a sandbox copy of a subset of coding components, and wherein the first development sandbox and the second development sandbox are further configured with common test data;
promoting, based on testing with the common test data, a first product component from the first development sandbox and a second product component from the second development sandbox to a product component integration environment to generate an integrated product;
promoting, based on testing using the common test data, the integrated product to a staging environment to generate a staged product; and
promoting, based on staging and performance testing, the staged product to a production environment.

2. The method of claim 1, wherein the first development sandbox and the second development sandbox are each configured for an individual development team of a plurality of development teams within the product development environment.

3. The method of claim 2, further comprising:
1. creating, by the at least one processor, an additional product development sandbox for another development team of the plurality of product development teams in the product development environment, wherein the additional product development sandbox is configured to include the sandbox copy of the subset of coding components, and is further configured with the common test data.

4. The method of claim 1, wherein the subset of coding components comprises common coding components used by both of the first development sandbox and the second product development sandbox.

5. The method of claim 1, wherein the subset of coding components comprises common coding components modified by both the first development sandbox and the second product development sandbox.

6. The method of claim 1, wherein the common test data reflects a shared database of same data.

7. The method of claim 1, wherein the product component integration environment comprises successfully tested downstream product components.

8. The method of claim 1, wherein the staging environment comprises successfully tested downstream integrated product components.

9. The method of claim 1, wherein the production environment comprises staged and successfully performance tested downstream integrated product components.

10. The method of claim 1, wherein any of: the product component integration environment, the staging environment or the production environment comprises a sandbox environment.

11. The method of claim 1, further comprising implementing a code review before accepting the promoted first product component and the second product component.

12. The method of claim 1, further comprising implementing a code review before accepting the promoted integrated product component.

13. The method of claim 1, wherein the testing, by the at least one processor, the staged integrated product component to produce a performance tested product component further comprises:
testing the staged integrated product component for any of: load, speed, or stress.

14. A system, comprising:
a memory; and
at least one processor coupled to the memory and configured to:
create a plurality of product development sandboxes;
test, using common test data, a first product component of a first development sandbox of the plurality of product development sandboxes to produce a first tested product component;
test, using the common test data, a second product component of a second development sandbox of the plurality of product development sandboxes to produce a second tested product component;
promote the first tested product component and the second tested product component to a product component integration environment;
integrate the first tested product component and the second tested product component to produce an integrated product;
test, using the common test data, the integrated product to produce a tested integrated product;
promote the tested integrated product to a staging environment;
stage the tested integrated product to produce a staged product;
performance test the staged product to produce a performance tested product; and
promote the performance tested product to a production environment.

15. The system of claim 14, the at least one processor further configured to:
2. provide the first development sandbox and the second development sandbox with a sandbox copy of a subset of coding components and common test data.

16. The system of claim 14, wherein the subset of coding components comprises common used coding components used by both the first development sandbox and the second product development sandbox.

17. The system of claim 14, wherein the subset of coding components comprises common modified coding components used by both the first development sandbox and the second product development sandbox.

18. The system of claim 14, wherein the common test data reflects a common shared database.

19. The system of claim 14, wherein the product component integration environment, the staging environment and the production environment comprises successfully tested downstream product components.

20. A non-transitory computer-readable device having instructions stored thereon that, when executed by at least one computing device, causes the at least one computing device to perform operations comprising:
creating at least a first sandbox and a second sandbox in a product development environment, wherein the first sandbox and the second sandbox are configured to include a sandbox copy of a subset of coding components, and wherein the first sandbox and the second sandbox are further configured with common test data;
testing, based on the common test data, a first product component of the first sandbox to produce a first tested product component;
testing, based on the common test data, a second product component of the second sandbox to produce a second tested product component;
promoting the first tested product component and the second tested product component to a product component integration environment;
integrating the first tested product component and the second tested product component to produce an integrated product;
testing, based on the common test data, the integrated product to produce a tested integrated product;
promoting the tested integrated product to a staging environment;
staging the tested integrated product to produce a staged product;
testing the staged product to produce a performance tested product; and
promoting the performance tested product component to a production environment to generate a product.
